(19) United States
(12) Patent Application Publication
(10) Pub. No.: US 2018/0119358 A1
(43) Pub. Date: May 3, 2018

(54) SUBSTRATE WITH STRETCHABLE COATING

(71) Applicant: Billerudkorsnas AB, Solna (SE)

(72) Inventors: Mikael Larsson, Karlstad (SE); Micael Ragnarsson, Valberg (SE); Johannes Kritzinger, Olten (CH); Joachim Scholkopf, Oberkulm (CH)

(21) Appl. No.: 15/563,905

(22) PCT Filed: Mar. 31, 2016
(86) PCT No.: PCT/EP2016/057001

§ 371 Date: Oct. 2, 2017

(30) Foreign Application Priority Data
Mar. 31, 2015 (EP) 15161983.0

(51) Int. Cl. D21H 19/38; B41M 5/52; D21H 17/00; B41M 5/50; B65D 5/42; D21H 19/58; B65D 65/42; B65D 43/16

(52) U.S. Cl. CPC D21H 19/385; B41M 5/5218; D21H 17/73; B41M 5/508; B65D 43/162; B65D 5/4216; D21H 19/58; B65D 65/42; B41M 5/5254

(57) ABSTRACT

A coated paper material comprising a paper substrate coated with a composition comprising at least one acrylic binder having a Tg of −3° C. or lower and at least one inorganic filler having a BET specific surface area in the range of 1.0 to 30.0 m²/g, wherein the dry weight ratio of the at least one acrylic binder to the at least one inorganic filler is between 15:100 and 20:100.

### TECHNICAL FIELD

This disclosure relates primarily to paper substrates provided with a stretchable coating, and products comprising such coated paper substrates

### BACKGROUND

Pigment coatings are widely used to enhance optical properties, such as gloss and print quality, of paper and paperboard. Pigment coatings may also improve other properties of a paper or paperboard product.

### SUMMARY

The present inventors have observed an impaired visual impression of the print on pigment-coated paper products after the paper products have been stretched. The inventors have realized that the problem is caused by cracks formed in the pigment coating layer during stretching.

The stretching in question may for example occur when a sheet of the paper product is given a three-dimensional shape in a press-forming or thermo-forming operation. Further, the stretching may occur when the paper product is bended or folded, e.g. to form a package.

Accordingly, the present inventors have realized that there is a need for a paper substrate provided with a “stretchable coating”, i.e. a coating that does not crack to such an extent that the visual impression of a print on the coating is significantly impaired when the paper substrate is stretched.

The following itemized listing of embodiments of the present disclosure is presented to meet the above-mentioned need.

1. A coated paper material comprising a paper substrate coated with a composition comprising:

at least one acrylic binder having a glass transition temperature (Tg) of −3° C. or lower, and

at least one inorganic filler having a BET specific surface area in the range of 1.0 to 30.0 m²/g, wherein the dry weight ratio of the at least one acrylic binder to the at least one inorganic filler is between 15:100 and 20:100, such as between 16:100 and 20:100.

2. The coated paper material according to item 1, wherein the paper substrate comprises at least two paper layers including a top paper layer that is coated with the composition.

3. The coated paper material according to item 1 or 2, wherein the stretchability (ISO 1924/3) of the paper substrate or the top paper layer thereof is at least 3% in the machine direction (MD) and/or the cross direction (CD).

4. The coated paper material according to item 3, wherein the stretchability (ISO 1924/3) of the paper substrate or a top paper layer thereof is at least 5% in the machine direction (MD) and/or the cross direction (CD).

5. The coated paper material according to item 4, wherein the stretchability (ISO 1924/3) of the paper substrate or a top paper layer thereof is at least 7% in the machine direction (MD) and/or the cross direction (CD).

6. The coated paper material according to any one of the preceding items, wherein the stretchability (ISO 1924/3) of the paper substrate or a top paper layer thereof is at least 12% in the machine direction (MD).

7. The coated paper material according to any one of the preceding items, wherein the Tg of the at least one acrylic binder is −10° C. or lower, such as −15° C. or lower, such as −20° C. or lower.

8. The coated paper material according to any one of the preceding items, wherein the BET specific surface area of the at least one inorganic filler is in the range of 2.0 to 20.0 m²/g, such as 3.0 to 17.5 m²/g, such as 4.0 to 15 m²/g, such as 5.0 to 13 m²/g.

9. The coated paper material according to any one of the preceding items, wherein the at least one acrylic binder is selected from the group consisting of:
acrylic homopolymers;
methacrylic homopolymers;
copolymers composed of at least two different monomers, one monomer having an acrylic or methacrylic functional group and the other monomer having a functional group selected from the group consisting of styrene, vinyl and allyl; and
mixtures thereof.

10. The coated paper material according to any one of the preceding items, wherein the at least one acrylic binder is an acrylic homopolymer, a vinyl-acrylic copolymer, a styrene-acrylic copolymer, or a mixture thereof.

11. The coated paper material according to any one of the preceding items, wherein the weight median particle size d₅₀ of the at least one inorganic filler is in the range of 0.1 to 5.0 μm, such as 0.3 to 3.0 μm, such as 0.4 to 2.0 μm, such as 0.5 to 1.5 μm.

12. The coated paper material according to any one of the preceding items, wherein the weight median particle size d₉₈ of the at least one inorganic filler is in the range of 1.0 to 20.0 μm, such as 2.0 to 12.0 μm, such as 3.0 to 6.0 μm.

13. The coated paper material according to any one of the preceding items, wherein the at least one inorganic filler is selected from the group consisting of calcium carbonate containing material, talc, kaolin, clay, titanium dioxide, satin white, bentonite and mixtures thereof.

14. The coated paper material according to item 13, wherein the at least one inorganic filler is selected from the group consisting of calcium carbonate containing material, clay, kaolin and mixtures thereof.

15. The coated paper material according to item 14, wherein the at least one inorganic filler is a calcium carbonate containing material.

16. The coated paper material according to item 15, wherein calcium carbonate containing material is selected from the group consisting of natural ground calcium carbonate (GCC), precipitated calcium carbonate (PCC), dolomite and mixtures thereof.

17. The coated paper material according to item 16, wherein calcium carbonate containing material is natural ground calcium carbonate selected from the group consisting of marble, limestone, chalk and mixtures thereof.

18. The coated paper material according to item 16, wherein calcium carbonate containing material is precipitated calcium carbonate selected from the group consisting of rhombohedral PCC (R-PCC), scalenohedral PCC (S-PCC) and aragonitic PCC (A-PCC).

19. The coated paper material according to any one of the preceding items, wherein the at least one acrylic binder and the at least one inorganic filler together constitute at least 90 wt.-% of the composition, based on the dry weight of the composition.

20. The coated paper material according to any one of the preceding items, wherein the composition comprises at least one further additive selected from the group consisting of thickeners, lubricants, dispersants, milling aids, rheology modifiers, defoamers, optical brighteners, dyes, pH controlling agents and mixtures thereof.

21. The coated paper material according to any one of the preceding items, wherein the at least one inorganic filler constitutes 75 to 88 wt.-% of the composition, based on the dry weight of the composition.

22. The coated paper material according to any one of the preceding items, wherein the at least one acrylic binder constitutes 12 to 17 wt.-% of the composition, based on the dry weight of the composition.

23. The coated paper material according to any one of the preceding items, wherein the at least one further additive constitutes 0.1 to 8 wt.-% of the composition, based on the dry weight of the composition.

24. The coated paper material according to any one of the preceding items, wherein the paper substrate or at least a layer thereof is composed of Kraft paper.

25. The coated paper material according to any one of the preceding items, wherein a coated surface of the coated paper material is printed.

26. The coated paper material according to item 25, wherein the printed surface is covered by a barrier layer.

27. The coated paper material according to any one of items 1-24, wherein a coated surface is covered by a barrier layer.

28. A blank provided with folding lines, which blank is composed of the coated paper material according to any one of the preceding items.

29. A package comprising at least one wall composed of the coated paper material according to any one of items 1-27.

30. A package comprising at least two walls composed of the coated paper material according to any one of items 1-27, which walls are joined by an edge defined by a folding line formed in the coated paper material.

31. A box comprising a bottom wall and at least two side walls composed of the coated paper material according to any one of items 1-27.

32. A three-dimensional article comprising structural elements composed of a coated paper material according to any one of items 1-27

33 The coated paper material, blank, package or box according to any one of the preceding items comprising a bulge or relief formed by stretching a portion of the coated paper material.

34. A method of forming a three-dimensional pattern comprising a step of subjecting an article comprising a coated paper material according to any one of items 1-27 to a forming operation, such as press-forming or thermo-forming, to form the three-dimensional pattern in the coated paper material, wherein part of the coated paper material is stretched during the forming operation.

### BRIEF DESCRIPTION OF THE DRAWINGS

The invention is now described, by way of example, with reference to the accompanying drawings, in which:

FIGS. 1a-1d illustrate different embodiments of a coated paper material according to the present disclosure.

FIGS. 2A and 2B illustrate a blister pack composed of a coated paper material according to the present disclosure that has been stretched in a forming operation.

FIGS. 3 and 4A-B illustrate trays composed of a coated paper material according to the present disclosure that has been stretched in a forming operation.

FIGS. 5A-B illustrate a clamshell package composed of a coated paper material according to the present disclosure that has been stretched in a forming operation.

FIG. 6 illustrates a base portion of another clamshell package. The vase portion is composed of a coated paper material according to the present disclosure that has been stretched in a forming operation.

FIG. 7 illustrates a sleeve 700 composed of a coated paper material according to the present disclosure. Part of the sleeve has been stretched in a forming operation such that a decorative/descriptive relief text is obtained.

FIG. 8 illustrates a box for a wine bottle composed of a coated paper material according to the present disclosure. Part of the coated paper material has been stretched in a forming operation such that a decorative/descriptive relief in the shape of a wine bottle is formed in a side wall of the box.

FIGS. 9a-d show different views of a 3D formability tester used in the experiments; a diagonal top view (FIG. 1a), side view (FIG. 1b), top view (FIG. 1c) and front view (FIG. 1d).

### DETAILED DESCRIPTION

As a first aspect of the present disclosure, there is thus provided a coated paper material comprising a paper substrate coated with a composition.

The paper substrate may for example comprise at least two paper layers. In such case, the substrate will have a top paper layer and a bottom paper layer. Further, the top paper layer will be coated with the composition. Optionally, the bottom paper layer is also coated with the composition. This means that the top surface of the paper substrate is covered by the coating composition and the bottom surface of the paper substrate is optionally covered by the coating composition.

The coat weight of each coating layer may for example be 4-40 g/m², such as 5-35 g/m², such as 5-30 g/m², such as 8-30 g/m², such as 8-25 g/m², such as 15-25 g/m². If the coat weight is too low, there is a great risk that areas of insufficient coverage is obtained. A coating layer may comprise two or more sublayers. In the case of two sublayers, the BET specific surface area of the inorganic filler in the top sublayer may be larger than the BET specific surface area of the inorganic filler in the other sublayer. In the case of more than two sublayers, the BET specific surface area of the inorganic filler in the top sublayer may be larger than the BET specific surface area of the inorganic filler in one or all of the other sublayers. Thereby, the printability may be improved with maintained stretchability. The coat weight of each sublayer is preferably at least 6 g/m², such as at least 8 g/m².

The paper substrate may for example be a laminate, in which at least two paper layers are adhered to each other. The adhesive may for example be a layer of polyethylene (PE), a water-based glue or an organic solvent-based glue. The amount of adhesive provided between two layers in the paper substrate may for example be 2-35 g/m², such as 4-20 g/m².

The grammage of the paper substrate may for example be 40-550 g/m², such as 75-550 g/m². When the paper substrate comprises a single paper layer, the grammage of the paper substrate may for example be 40-200 g/m², such as 50-150 g/m² or 75-200 g/m². When the paper substrate comprises at least two paper layers, the grammage of the paper substrate may for example be 80-550 g/m², such as 100-550 g/m², such as 150-500 g/m². When the paper substrate comprises at least three paper layers, the grammage of the paper substrate may for example be 175-550 g/m², such as 250-550 g/m², such as 300-550 g/m².

In embodiments of the first aspect, the stretchability (ISO 1924/3) of the paper substrate is at least 3% in the machine direction (MD) and/or the cross direction (CD). In preferred embodiments, the stretchability (ISO 1924/3) of the paper substrate is at least 5 or 7% in the machine direction (MD) and/or the cross direction (CD). In one embodiment, the stretchability (ISO 1924/3) of the paper substrate is at least 12% or 14% in the machine direction (MD).

A non-limiting example of a suitable material for the paper substrate is FibreForm® marketed by BillerudKorsnäs AB (Sweden). In FibreForm®, the stretchability is at least 7% in the CD and at least 13% in the MD.

In the embodiments wherein the paper substrate comprises more than one layer, the stretchability (ISO 1924/3) of top layer may be at least 3, 5, 7, 12 or 14% in the machine direction (MD) and/or the cross direction (CD). In such embodiments, the stretchability (ISO 1924/3) of at least one other layer may be below 5 or 3% in the machine direction (MD) and/or the cross direction (CD).

It is understood from the discussion above that the benefits of the stretchability of the coating of the present disclosure is more relevant when the stretchability of the paper substrate (or at least the top layer thereof) is higher.

A paper substrate or paper layer of the present disclosure having a stretchability of at least 5% in the machine direction (MD) and/or the cross direction (CD) is preferably at least partly obtained from chemical pulp, which generally has longer fibres than mechanical pulp. For example, the paper substrate or paper layer having such stretchability may be composed of Kraft paper. In one embodiment, the paper substrate comprises more than one layer and at least the top layer is composed of Kraft paper.

The inventors have noted that the stretchability of the composition partly depends on the Tg of the acrylic binder. If the Tg is too high, the stretchability is insufficient. Accordingly, the composition of the present disclosure comprises at least one acrylic binder having a Tg of −3° C. or lower, preferably −10° C. or lower and more preferably −15° C. or lower. In one embodiment, the Tg is −20° C. or lower. A binder having a Tg of −25° C. has been shown to result in particularly beneficial coating properties.

If the Tg is too low, the coating may become too sensitive. Therefore, the Tg may be above −85° C., such as above −70° C., such as above −45° C.

Preferred Tg ranges are −15 to −30° C., such as −20 to −30° C.

The glass transition temperature (Tg) is a well-known parameter to those skilled in the art, and is the temperature range, where a thermosetting polymer changes from a more pliable, compliant or “rubbery” state to a hard, rigid or “glassy” state upon cooling. The Tg is usually measured using Differential Scanning calorimetry (DSC): ASTM E1356, “Standard Test Method for Assignment of the Glass Transition Temperature by Differential Scanning calorimetry”. The Tg is actually a temperature range, rather than a specific temperature. The convention, however, is to report a single temperature defined as the midpoint of the temperature range, bounded by the tangents to the two flat regions of the heat flow curve.

In the context of the present disclosure, an “acrylic binder” refers to a polymeric binder comprising an acrylic monomer. Examples of acrylic monomers are methacrylates, methyl acrylate, ethyl acrylate, 2-ethylhexyl acrylate, hydroxyethyl methacrylate, butyl acrylate and butyl methacrylate.

The at least one acrylic binder is for example selected from the group consisting of: i) acrylic homopolymers; ii) methacrylic homopolymers iii) copolymers composed of at least two different monomers; and iv) mixtures thereof. “Mixtures thereof” refers to any mixture consisting of at least two of i)-iii).

In the copolymers of iii), one monomer has an acrylic or methacrylic functional group and the other monomer has a functional group selected from the group consisting of styrene, vinyl and allyl.

The at least one acrylic binder is preferably: a) an acrylic homopolymer; b) a vinyl-acrylic copolymer; c) a styrene-acrylic copolymer; or d) a mixture thereof. “Mixture thereof” refers to any mixture consisting of at least two of a)-c).

When the composition of the present disclosure is prepared, the acrylic binder is normally provided in the form of an aqueous dispersion. A specific example of a commercial aqueous dispersion of an acrylic homopolymer having a Tg of −30° C. is Appretan® E2100 (Archroma). A specific example of a commercial aqueous dispersion of a styrene-acrylic copolymer having a Tg of −25° C. is Primal™ 325 GB (Dow). A specific example of a commercial aqueous dispersion of a styrene-acrylic copolymer having a Tg of −20° C. is Appretan® E6200 (Archroma). A specific example of a commercial aqueous dispersion of a vinyl-acrylic copolymer having a Tg of −15° C. is Appretan® E4250 (Archroma).

In addition to acrylic binders, also polyurethane-based binders, vinyl acetate-based binders and polyester resins having a T_{g}<−3° C. may be suitable in aqueous coating compositions for stretchable coatings in paper and board applications.

The composition of the present disclosure further comprises at least one inorganic filler. The presence of filler in the coating improves printability and other properties. The at least one inorganic filler may be selected from the group consisting of calcium carbonate containing material, talc, kaolin, clay, titanium dioxide, satin white, bentonite and mixtures thereof. “Mixtures thereof” refers to any mixture of at least two of the foregoing examples of inorganic fillers.

Calcium carbonate containing material, clay, kaolin or a mixture thereof are preferred examples.

When the inorganic filler is a calcium carbonate containing material, it is preferably selected from the group consisting of natural ground calcium carbonate (GCC), precipitated calcium carbonate (PCC), dolomite and mixtures thereof.

GCC is a particularly preferred example. The GCC may for example be selected from marble, limestone, chalk and mixtures thereof.

Another preferred example is PCC, which may be selected from rhombohedral PCC (R-PCC), scalenohedral PCC (S-PCC) and aragonitic PCC (A-PCC).

The BET specific surface area of the at least one inorganic filler is within the range of 1.0 to 30 m²/g. Preferred ranges are 2.0 to 20 m²/g, 3.0 to 17.5 m²/g, 4.0 to 15 m²/g and 5.0 to 13 m²/g. It has been found that if the specific surface area of the filler is too large (i.e. >30 m²/g), cracks are easily formed in the coating. Without being bound by any specific scientific theory, the inventors believe that the average thickness of the binder films formed between the filler particles in the coating increases when the specific surface area of the filler decreases and that such an increase in thickness results in improved stretchability of the films and thus less crack formation.

The BET specific surface area is preferably measured with the analyzer Tristar II marketed by Micromeritics. Further, the measurement may be carried out according to the standard ISO 9277:1995.

It follows from the above that relatively large filler particles are preferred as they result in a smaller specific surface area. Further, the inventors speculate that if fine particles are present in high amounts, they may form flakes that increase the crackability of the coating. Accordingly, the amount of very small filler particles is preferably kept low. However, if the filler particles are too large or coarse, the printing surface may become too rough, which may result in unsatisfactory gloss and/or brightness. As known to the skilled person, particle size distribution may be quantified by d values. For determining the weight median particle size d₅₀ value or the top cut particle size do value a SediGraph 5100 or 5120 device from the company Micromeritics, USA, can be used.

Preferably, the weight median particle size d₅₀ of the at least one inorganic filler is in the range of 0.1 to 5.0 μm, such as 0.3 to 3.0 μm, such as 0.4 to 2.0 μm, such as 0.5 to 1.5 μm. Further, the weight median particle size d₉₈ of the at least one inorganic filler is in the range of 1.0 to 20.0 μm, such as 2.0 to 12.0 μm, such as 3.0 to 6.0 μm.

Specific examples of a commercial GCC (marble) products having a BET specific surface area in the range of 1 to 30 m²/g are Hydrocarb® 60—ME 78% (Omya), Hydrocarb® 90—ME 78% (Omya) and Setacarb® HG—ME 75% (Omya).

Hydrocarb® 60 has a weight median particle size d₅₀ of 1.4 μm and a weight median particle size d₉₈ of 10 μm. Hydrocarb® 90 has a weight median particle size d₅₀ of 0.7 μm and a weight median particle size d₉₈ of 5 μm. Setacarb® HG has a weight median particle size d₅₀ of 0.5 μm and a weight median particle size d₉₈ of 2 μm.

The inventors have found that another way of improving the stretchability of the coating is to have a relatively high ratio of the at least one acrylic binder to the at least one inorganic filler. The inventors believe that a relatively high ratio prevents crack formation as the film formed by the binder is less interrupted when the amount of filler is lower.

However, the ratio should not be too high, because in such case the printability of the coating surface is insufficient and the coating may become transparent. Further, the acrylic binder is generally more expensive than the inorganic filler and it is therefore beneficial to keep the ratio low from a cost perspective.

The inventors have identified a dry weight ratio of the at least one acrylic binder to the at least one inorganic filler in the range of 15:100 to 20:100 as an optimum when stretchability, printability and cost is taken into account.

Preferably, the ratio is in the range of 16:100 to 20:100.

In addition to the above-mentioned acrylic binder and inorganic filler, the composition of the present disclosure may at least one additive selected from the group consisting of:
thickeners (also referred as rheology modifiers), such as HASE rheology modifiers;
lubricants;
dispersants;
milling aids;
defoamers;
optical brighteners;
dyes; and
pH controlling agents.

As understood by the skilled person, the composition may also comprise a mixture consisting of two or more additives selected from the above.

However, the above-mentioned additives preferably constitute only a minor part of the composition, such as 0.1 to 8 wt.-% of the composition, based on the dry weight of the composition. Normally, the at least one acrylic binder and the at least one inorganic filler together constitute at least 90 wt.-% of the composition, based on the dry weight of the composition. In one embodiment, the at least one acrylic binder and the at least one inorganic filler together constitute at least 92 wt.-%, such as at least 92 wt.-%, of the composition, based on the dry weight of the composition.

It follows that the at least one inorganic filler for example constitutes 75 to 88 wt.-% of the composition, based on the dry weight of the composition.

It also follows that the at least one acrylic binder for example constitutes 12 to 17 wt.-% of the composition, based on the dry weight of the composition.

When the coated paper material of the present disclosure is prepared, the composition may be applied as an aqueous coating composition having a solids content in the range of from 50 to 75 wt.-%, preferably in the range of 60 to 72 wt.-%, and most preferably in the range of 65 to 70 wt.-%, based on the total weight of the aqueous coating composition.

In the preparation of the aqueous coating composition, the components may, independently from each other, be provided in dry form, or in the form of suspensions, dispersions, slurries or solutions, and be mixed in any order.

The mixing of the components may be carried out by any suitable mixing means known to those skilled in the art, for example a caddy mill. In one embodiment the aqueous coating composition may contain further solvents such as alcohol ethers, alcohols, aliphatic hydrocarbons, esters, and mixtures thereof.

The substrate may be coated, once or several times, with the aqueous coating composition, wherein the coating may be carried out by conventional techniques well-known in the art.

The coated substrate may be subjected to calendering.

In embodiments of the present disclosure, a coated surface of the coated paper material is printed. Thus, a print comprising ink, such as flexographic ink, may be formed on the coated surface. Examples of flexographic inks are solvent-based inks, water-based inks, electron beam (EB) curing inks and ultraviolet (UV) curing inks. The print on the coated surface may thus be obtained by means of flexography.

The printed surface of the above-mentioned embodiments may covered by a barrier layer. Also, a coated surface of the coated paper material may be covered by a barrier layer, which means that the surface covered by the barrier layer is not printed.

The barrier layer has one or more barrier properties. Examples of barrier properties include grease barrier, gas barrier and moisture barrier properties. Such barrier properties are for example of interest when food or liquids are packaged.

The barrier layer may for example comprise or consist of PE (e.g. HDPE, LLDPE or LDPE), PLA, PA, PET, PP or Lacquer hot melt. Such barrier materials enable heat-sealing: Further, the barrier layer may be a dispersion, a bio-based polymer, a bio-based binding material or a glue. In one embodiment, the barrier layer comprises a platy clay, such as a hyper-platy clay, e.g. BARRISURF™ (Imerys).

A benefit of PE and PP is that they are moisture barriers.

The barrier layer may comprise sublayers. For example, it may comprise a layer of EVOH, which is a gas barrier, sandwiched between two layers of polyolefin, such as PE or PP. The barrier layer may also be a multilayer PA-polymer structure (PA is also a gas barrier).

A blank of the coated paper material of the present disclosure may be provided with folding lines, such that it may be folded into a three-dimensional object, such as a package (e.g. a box) or a part thereof (e.g. a lid).

It follows that a package may comprise at least one wall comprising or composed of the coated paper material of the present disclosure. In one embodiment of such a package, at least two walls are composed of the coated paper material according to the present disclosure, which walls are joined by an edge defined by a folding line formed in the coated paper material. A box may comprise a bottom wall and at least two side walls composed of the coated paper material of the present disclosure.

In a coated paper material, blank, package or box according to the present disclosure, a three-dimensional pattern, such as a bulge or relief, may be formed in the coated paper material. When such a three-dimensional pattern is formed, a portion of the coated paper-material is stretched.

As a second aspect of the present disclosure, there is provided a method of forming a three-dimensional pattern comprising a step of subjecting an article comprising a coated paper material of the present disclosure to a forming operation to form the three-dimensional pattern in the coated paper material. During the forming operation, part of the coated paper material is stretched. Hence, there is a benefit of using the stretchable coating of the present disclosure. The forming operation may for example be press-forming or thermo-forming.

In an embodiment, the coated paper material is calendered before being subjected to the forming operation.

### Exemplary Embodiments

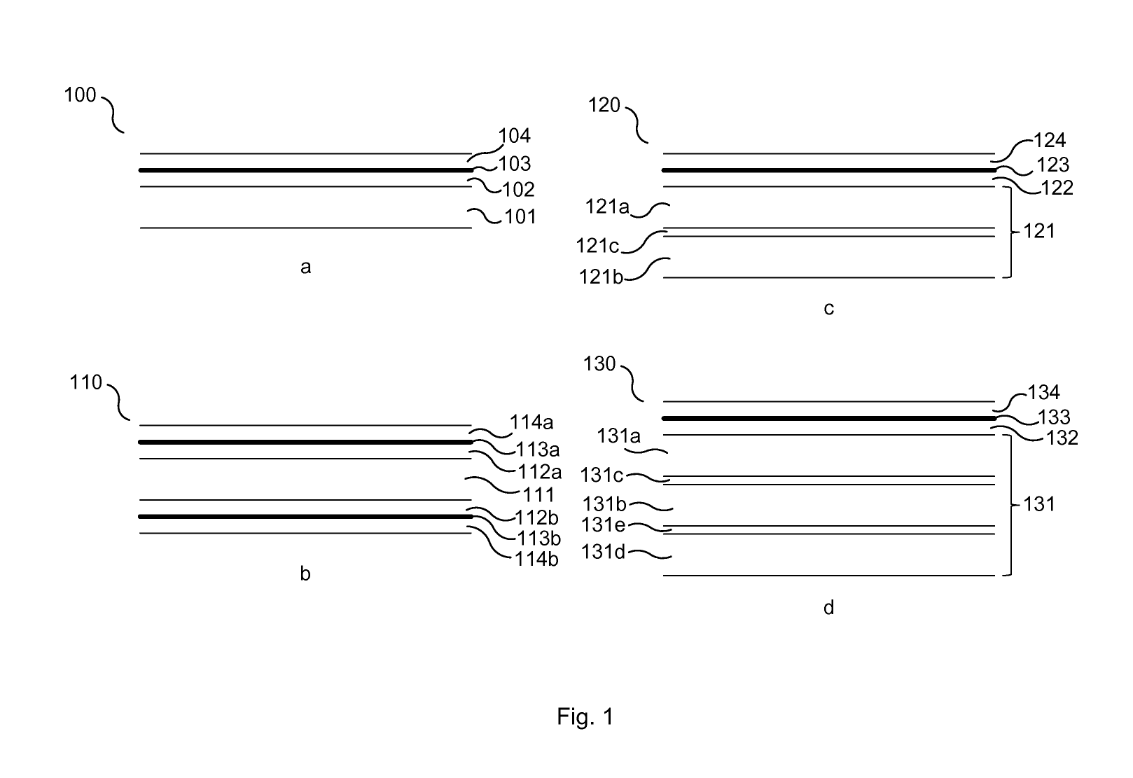

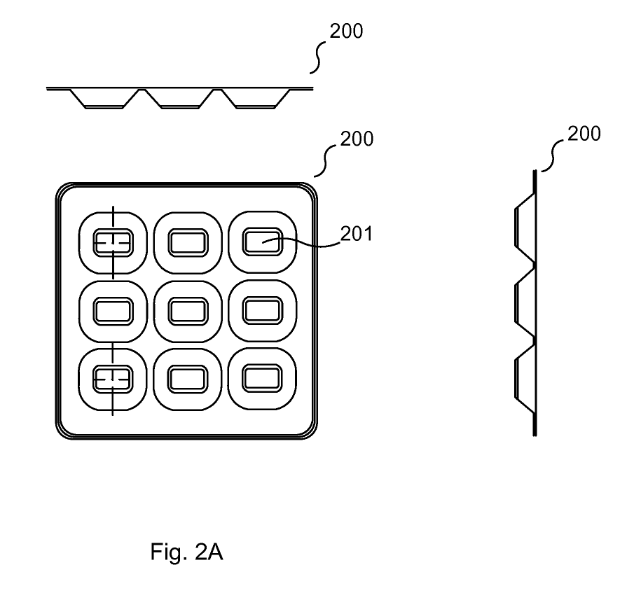

FIG. 1a is shows a non-limiting embodiment of a coated paper material 100 according to the present disclosure. The material 100 comprises a paper substrate 101 consisting of a single paper layer. The paper substrate 101 is preferably stretchable. For example, it may be composed of FibreForm® (BillerudKorsnäs AB, Sweden).

The stretchability of FibreForm® is at least 7% in the CD and at least 13% in the MD when measured according to ISO 1924/3. The top surface of the paper substrate 101 is covered by a coating layer 102 consisting of a composition comprising an inorganic filler (e.g. calcium carbonate pigment) and an acrylic binder (e.g. styrene-acrylic copolymer). The coating layer 102 is printed such that a printing layer 103 is obtained. The printing layer 103 thus comprises ink. In turn, the printing layer 103 is covered by a barrier layer 104 having one or more barrier properties.

Examples of barrier properties include grease barrier, gas barrier and moisture barrier properties. Such barrier properties are for example of interest when foods are packaged. The barrier layer 104 may have been applied to the printing layer by a coating method. Alternatively the barrier layer 104 may have been applied by gluing a plastic film to the printing layer. The barrier layer 104 may for example comprise two or more sublayers. For example, it may comprise a first and a second sub-layer consisting of PE and a third sub-layer, arranged between the first in and the second 112 sub-layer, consisting of EVOH. In such case, the PE layers mainly function as moisture barriers while the EVOH layer mainly functions as a gas barrier.

FIG. 1b shows another non-limiting embodiment of a coated paper material 110 according to the present disclosure. The material 110 comprises a paper substrate in consisting of a single paper layer. As in the embodiment of FIG. 1a, the paper substrate 111 is preferably stretchable and may be composed of FibreForm®. The top surface of the paper substrate 111 is covered by a coating layer 112a consisting of a composition comprising an inorganic filler (e.g. calcium carbonate pigment) and an acrylic binder (e.g. styrene-acrylic copolymer). Further, the bottom surface of the paper substrate 111 is covered by a coating layer 112b consisting of the same composition. The coating layers 112a, 112b are printed such that a top printing layer 113a and a bottom printing layer 113b are obtained. In turn, the printing layers 113a, 113b are covered by top and bottom barrier layers 1o4a, 104b having one or more barrier properties. Barrier layers and their properties are discussed above in connection with FIG. 1a. The barrier properties of the top barrier layer 114a and the barrier properties of the bottom barrier layer 114b are not necessarily the same. For example, the top barrier layer 114a may comprise three sublayers as described above in connection with FIG. 1a and thus have moisture and gas barrier properties, wile the bottom barrier layer consists of PE and mainly functions as a moisture barrier.

FIG. 1c shows another non-limiting embodiment of a coated paper material 120 according to the present disclosure. The material 120 comprises a paper substrate 121 that is a laminate comprising a first (top) 121a and a second (bottom) 121b paper layer. Between the first 121a and the second 121b paper layer, a polyethylene (PE) layer 121C is provided as an adhesive. The amount of PE may for example be 20-30 g/m². The first and the second paper layers 121a and 121b are stretchable and preferably composed of FibreForm®. Accordingly, the entire paper substrate 121 is stretchable. The top surface of the first (top) paper layer 121a is covered by a coating layer 122 consisting of a composition comprising an inorganic filler (e.g. calcium carbonate pigment) and an acrylic binder (e.g. styrene-acrylic copolymer). The coating layer 122 is printed such that a printing layer 123 is obtained. In turn, the printing layer 123 is covered by a barrier layer 124 having one or more barrier properties. Barrier layers and their properties are discussed above in connection with FIG. 1a.

FIG. 1d shows another non-limiting embodiment of a coated paper material 130 according to the present disclosure. The material 130 comprises a paper substrate 131 that is a laminate comprising a first (top) paper layer 131a, a second (middle) paper layer 131b, and a third (bottom) paper layer 131d. The second paper layer 131b is thus sandwiched between the first 131a and the third 131d paper layer. Between the paper layers 131a, 131b, 131d, polyethylene (PE) layers 131c, 131e are provided as adhesive. The amount of PE in each PE layer may for example be 20-30 g/m². The first and the third paper layers 131a and 131b are highly stretchable and preferably composed of FibreForm®. The second paper layer 131b is however significantly less stretchable than FibreForm® and may be for example be formed from pulp comprising mechanical pulp, thermomechanical pulp (TMP) and/or chemithermomechanical pulp (CTMP). Accordingly, the entire paper substrate 131 is not highly stretchable, but the outer paper layers 131a and 131d are. The top surface of the first (top) paper layer 131a is covered by a coating layer 132 consisting of a composition comprising an inorganic filler (e.g. calcium carbonate pigment) and an acrylic binder (e.g. styrene-acrylic copolymer). The coating layer 132 is printed such that a printing layer 133 is obtained. In turn, the printing layer 133 is covered by a barrier layer 134 having one or more barrier properties. Barrier layers and their properties are discussed above in connection with FIG. 1a.

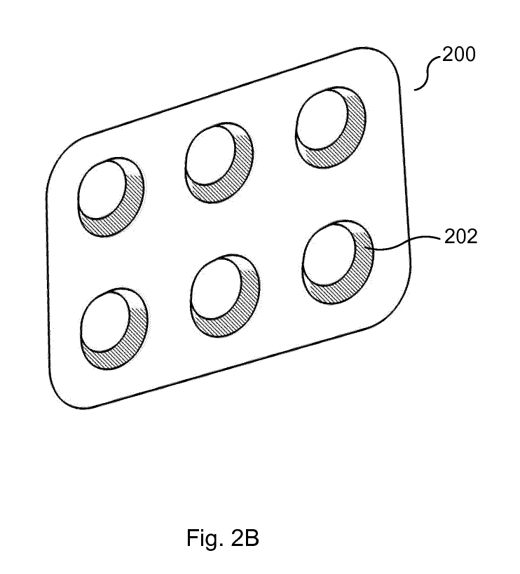

FIG. 2A shows a blister pack 200 formed in a coated paper material according to the present disclosure. A coated side is printed. The print is preferably covered by a barrier layer providing protection against gas and moisture (and possibly grease). The paper substrate of the material is composed of FibreForm®. The stretchability of the paper substrate and the coating enables the formation of a plurality of cavities 201 in the blister pack 200, e.g. by press-forming, thermo-forming or vacuum-forming, without significant impairment of the visual impression of the print. FIG. 2B shows how the underside of the cavities 201 appear as bulges 202 on the opposite side of the blister pack 200.

The blister pack 200 may for example be designed to contain pills (such as medical pills) or candy. It is understood that the cavities 201 of the blister pack 200 may be covered by a film or foil composed of plastic or aluminium, which film or foil is broken to obtain the contents of the blister pack 200.

The grammage of coated paper material of the blister pack may for example be 150-300 g/m2.

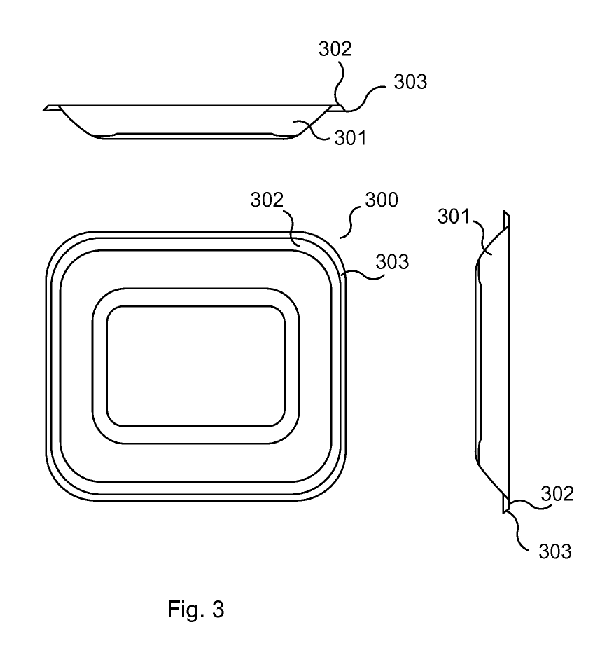

FIG. 3 shows a rectangular tray 300 with rounded corners formed in a coated paper material according to the present disclosure. The paper substrate is composed of FibreForm®. A coated side of the material is printed. If the tray 300 is intended for foodstuffs, the coated paper material preferably comprises one or more barriers against gas and moisture and possibly grease. The stretchability of the substrate and the coating enables the formation of a body portion 301 and a circumferential rim portion 302 without significant impairment of the visual impression of the print. The body portion 301 comprises side walls and a bottom wall. The outer edge 303 of the rim portion 302 is bent downwards for increased stability and improved aesthetics. The tray 300 may be formed by press-forming, thermo-forming or vacuum-forming.

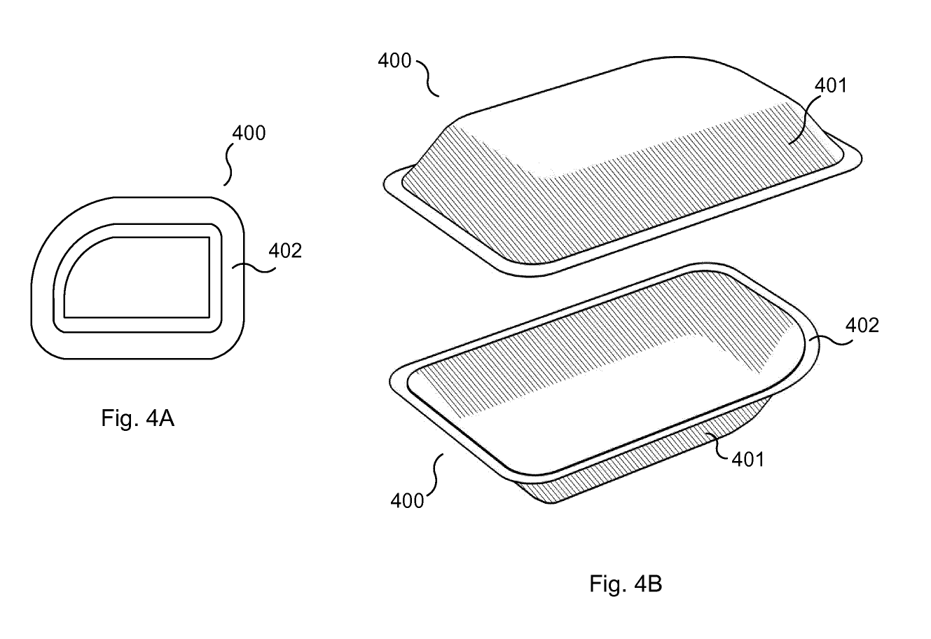

FIGS. 4A-B show another embodiment of a tray 400, which is not rectangular, formed in a coated paper material according to the present disclosure. The paper substrate is composed of FibreForm®. A coated side of the material is printed. If the tray 400 is intended for foodstuffs, the coated paper material preferably comprises one or more barriers against gas and moisture and possibly grease. The stretchability of the paper substrate and the coating enables the formation of a body portion 401 and a flat circumferential rim portion 402 without significant impairment of the visual impression of the print. The body portion 401 comprises side walls and a bottom wall. The tray 400 may be formed by press-forming, thermo-forming or vacuum-forming. The tray 300, 400 may for example be covered with a film, such as an optionally transparent plastic film, to protect the contents of the tray 300, 400, such as food. Such a film is preferably releasably adhered to the rim portion 302, 402 of the tray 300, 400.

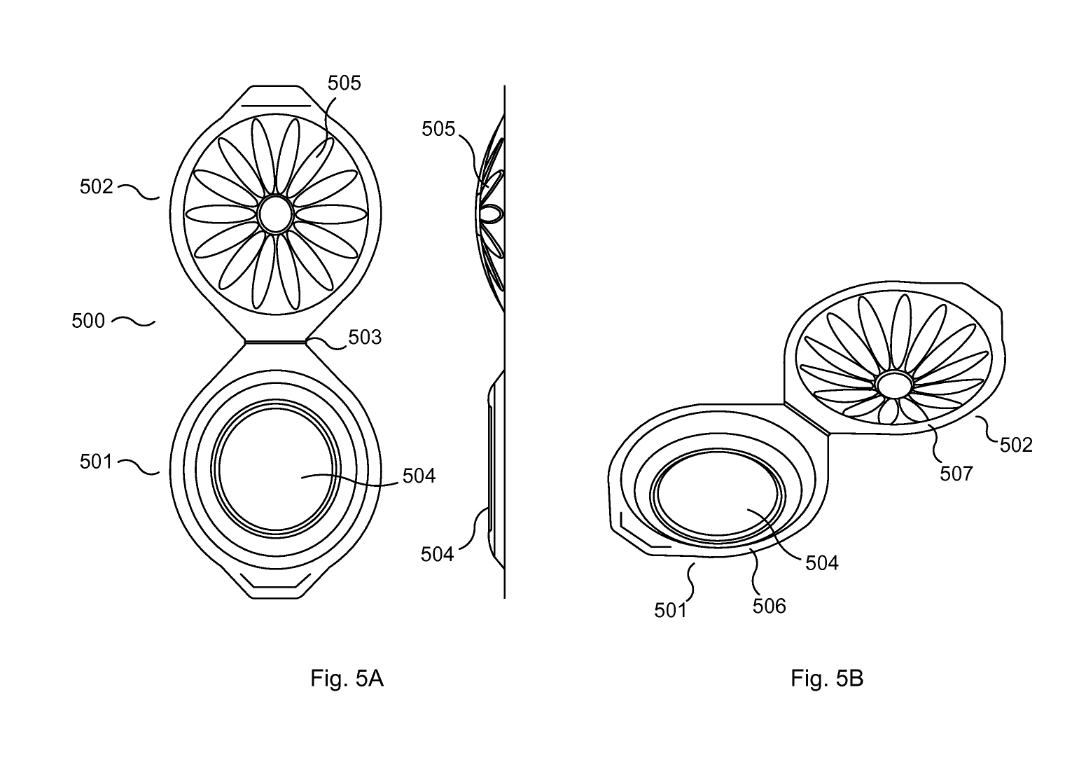

FIG. 5A-B show different views of an embodiment of a clamshell package 500 formed in a coated paper material according to the present disclosure. The paper substrate is composed of FibreForm®. A coated side of the material is printed. The clamshell package 500 comprises a generally bowl-shaped base portion 501 hingedly connected to a generally bowl-shaped top portion 502. Thus, the clamshell package 500 may be closed by folding along a hinging fold line 503. The base portion 501 comprises a generally flat bottom 504 and the top portion 502—in this non-limiting example—comprises a decorative embossing 505 schematically illustrating a flower. A substantially flat rim 506 of the base portion 501 is sealable against a substantially flat rim 507 of the top portion 502.

The stretchability of the paper substrate and the coating enables the bowl shapes of the bottom portion 501 and the top portion 502 as well as the decorative embossing 505 without significant impairment of the visual impression of the print. The clamshell package 500 may be formed by press-forming, thermo-forming or vacuum-forming. Vacuum forming or thermoforming normally requires that the paper material is provided with a gas barrier.

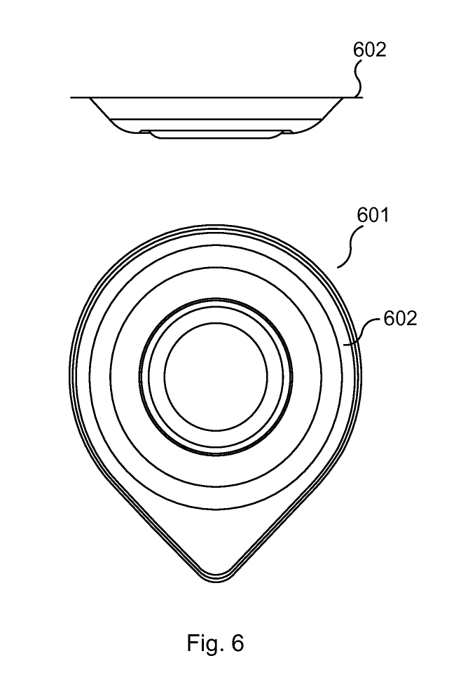

FIG. 6 shows a base portion 601 of another embodiment of a clamshell package formed in a coated paper material according to the present disclosure. The paper substrate is composed of FibreForm®. A coated side of the material is printed. The base portion 601 is generally bowl-shaped and comprises a substantially flat rim 602 that is sealable against a corresponding rim of a top portion (not shown). The stretchability of the paper substrate and the coating enables allows the bowl shape to form without significant impairment of the visual impression of the print.

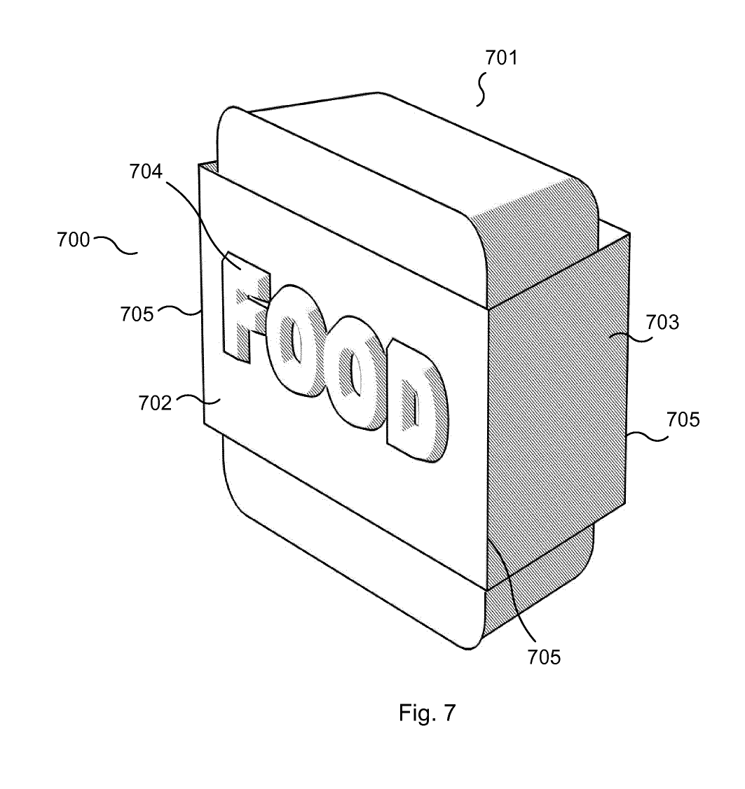

FIG. 7 schematically illustrates a sleeve 700 formed in a coated paper material according to the present disclosure. The paper substrate is composed of FibreForm®. An outer side of the sleeve is coated and printed. The sleeve 700 comprises a top wall 702, two opposing side walls 703 and a bottom wall. In this non-limiting example, the sleeve 700 is arranged around a food-containing plastic package 701. As an example, a decorative and/or descriptive relief text (“FOOD”) 704 has been formed in the upper wall 702 of the sleeve 200. The stretchability of the stretchable of the paper substrate and the coating allowed the relief text 704 to be formed in the top wall 702 without significant impairment of the visual impression of the print. The walls 702, 703 are joined by edges 705 defined by folding lines. The sleeve 700 is thus formed by folding and gluing a blank provided with folding lines.

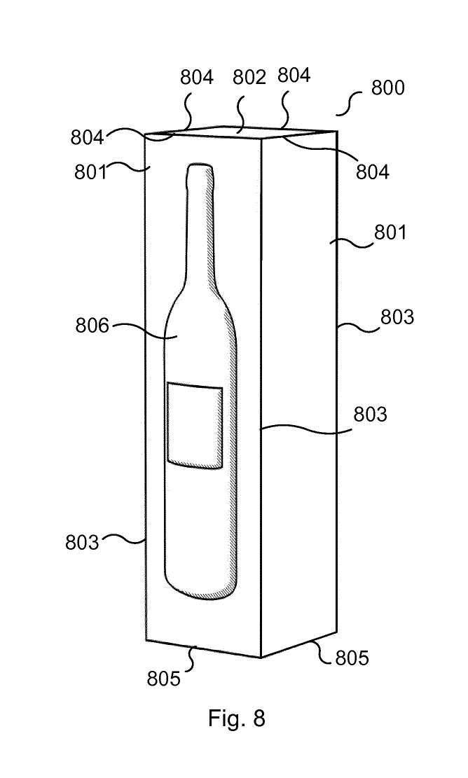

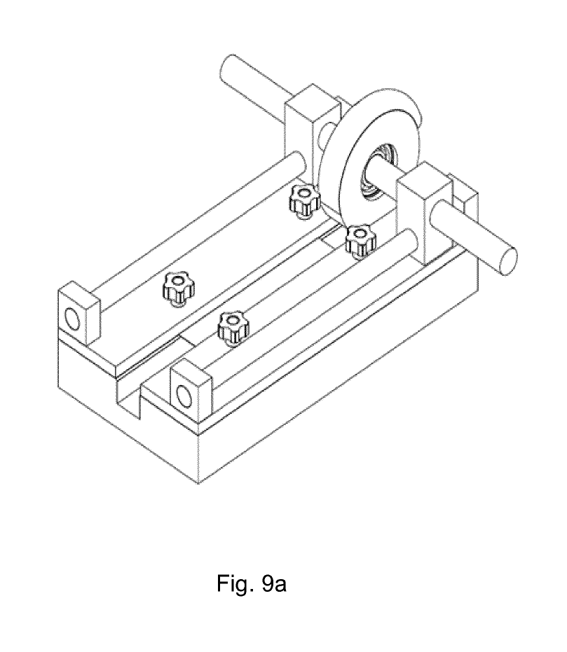

FIG. 8 illustrates a box 80o for a wine bottle, another non-limiting example. The box 800, which comprises four side walls 801, a top wall 802 and a bottom wall, is folded from a blank composed of a coated paper material according to the present disclosure. The paper substrate is composed of FibreForm®. The side of the material facing outwards is coated and printed. A decorative and/or descriptive relief 806 is here shown in the shape of a wine bottle formed in a side wall 801. The stretchability of the paper substrate and the coating allowed the relief 806 to be formed without significant impairment of the visual impression of the print. The box comprises four vertical edges 803, four horizontal edges 804 at the top and the four horizontal edges 805 at the bottom. At least three of the four vertical edges 803 are defined by folding lines made in the blank. Further, at least two of the four horizontal edges 804 at the top and at least two of the four horizontal edges 805 at the bottom are defined by folding lines made in the blank.

### EXPERIMENTAL SECTION

I. Measurement Methods

1. Particle Size Distribution

In the experiments, the d₅₀ and d₉₈ values were measured using a Sedigraph® 5120 from the company Micromeritics, USA. The method and the instrument are known to the skilled person and are commonly used to determine grain size of fillers and pigments. The measurements were carried out in an aqueous solution comprising 0.1 wt.-% Na₄P₂O₇. The samples were dispersed using a high speed stirrer and supersonics. For the measurement of dispersed samples, no further dispersing agents were added.

2. Solids Content of an Aqueous Suspension

The suspension solids content (also known as “dry weight”) was determined using a Mettler Toledo™ Moisture Analyser MJ33 from the company Mettler Toledo, Switzerland, with the following settings: drying temperature of 160° C., automatic switch off if the mass does not change more than 1 mg over a period of 30 s, standard drying of 5 to 20 g of suspension.

3. Specific Surface Area (SSA)

The specific surface area was measured via the BET method according to ISO 9277 using nitrogen, following conditioning of the sample by heating at 250° C. for a period of 30 minutes. Prior to such measurements, the sample is filtered within a Büchner funnel, rinsed with deionized water and dried overnight at 90 to 100° C. in an oven. Subsequently the dry cake is ground thoroughly in a mortar and the resulting powder placed in a moisture balance at 130° C. until a constant weight is reached.

4. CIE Whiteness

CIE whiteness was determined according to ISO 11457.

5. Parker Print Surfaces (PPS) Smoothness

Surface smoothness given as Parker Print Surface was determined according to ISO 8791-4.

II. Materials

6. Substrate

FibreForm® 3D paper of 100% primary fibre; basis weight of 100 g/m² (available from BillerudKorsnäs; Sweden). The paper is characterized by its high elongation at break.

7. Fillers

In the experiments, five different fillers were used:

Filler 1: natural ground calcium carbonate; d₅₀=0.7 μm; d₉₈=5.0 μm; BET SSA=11.5 m²/g; solids content 78 wt.-% (available from Omya, Switzerland)

Filler 2: natural ground calcium carbonate; d₅₀=1.5 μm; d₉₈=10.0 μm; BET SSA=6.8 m²/g; solids content 78 wt.-% (available from Omya, Switzerland)

Filler 3: natural ground calcium carbonate; d₅₀=0.4 μm; d₉₈=2.0 μm; BET SSA=18.0 m²/g; solids content 75 wt.-% (available from Omya, Switzerland)

Filler 4: Clay No. 1 (Hydragloss 90), high brightness ultrafine clay, BET SSA=21 m²/g; solids content 73 wt.-% (available from Omya, Switzerland)

Filler 5: Sachtleben® R 320, rutile titanium dioxide; BET SSA=13 m²/g; (available from Sachtleben Chemie GmbH, Germany)

8. Binders

The following commercial binders were used in the experiments:

Appretan® E2100: pure acrylic dispersion; T_{g}−30° C. (available from Archroma)

Appretan® E6200: styrene/acrylic dispersion; T_{g}−20° C. (available from Archroma)

Appretan® E4250: vinyl/acrylic dispersion; T_{g}−15° C. (available from Archroma)

Primal® 325 GB: styrene/acrylic dispersion; T_{g}−25° C. (available from Dow Chemical Company)

Primal® P-308 MS: styrene/acrylic dispersion; Tg+8° C. (available from Dow Chemical Company)

Plextol® D270: aqueous emulsion of a thermoplastic acrylic polymer; T_{g}−42° C. (available from Synthomer Deutschland GmbH, Germany)

Plextol® D5240: acrylic ester copolymer dispersion; T_{g}−43° C. (available from Synthomer, Germany)

Plextol® X 4427: aqueous emulsion of an acrylic copolymer; T_{g}−40° C. (available from Synthomer, Germany)

Litex® P5100: carboxylated styrene/butadiene copolymer dispersion; Tg−2° C. (available from Synthomer, Germany)

Litex® SX 1024: styrene/buradiene copolymer dispersion; Tg−15° C. (available from Synthomer, Germany)

Litex® S 7641: self-crosslinking styrene/butadiene copolymer dispersion; Tg−44° C. (available from Synthomer, Germany)

9. Additives

Rheocarb® 101: steric rheology modifier (available from Coatex Arkema, France)

Rheocarb® 121: steric rheology modifier (available from Coatex Arkema, France)

PVA BF-04: fully hydrolyzed Polyvinylalcohol (available from Chang Chun Petrochemical Co., Ltd., Taiwan)

III. Methods

10. Coating Preparation

In the experiments, different coating compositions were prepared and evaluated as described below. The respective filler slurries and binder slurries were combined in a beaker by gentle mixing resulting in coating compositions having initial solids contents. Subsequently, the aqueous coating compositions were mixed under higher shear conditions without drawing air until the individual phases of the composition were visually homogenously mixed. For adjustment of final solids contents of the aqueous coating compositions, calculated amounts of water were added by mixing again under higher shear conditions without drawing air. All mixing steps were done with a Pendraulik Laboratory Dissolver, model LD 50.

11. Stretchability Testing Method

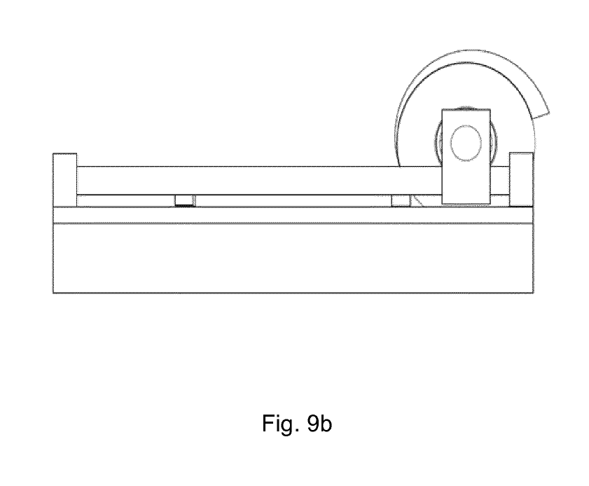

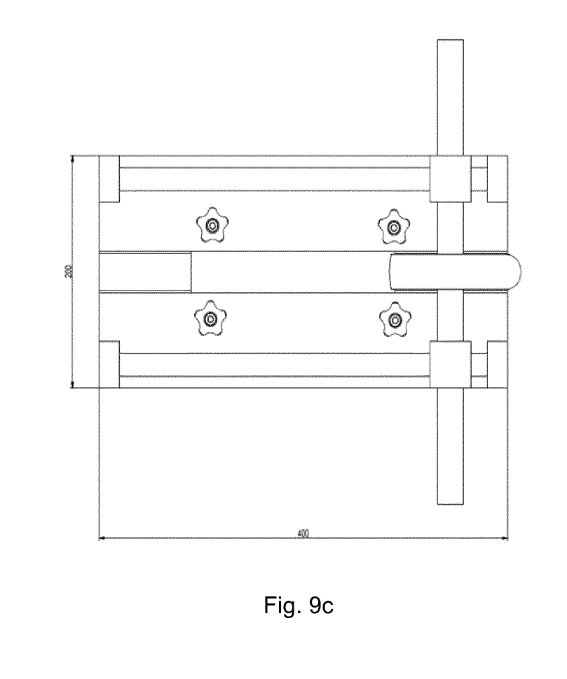

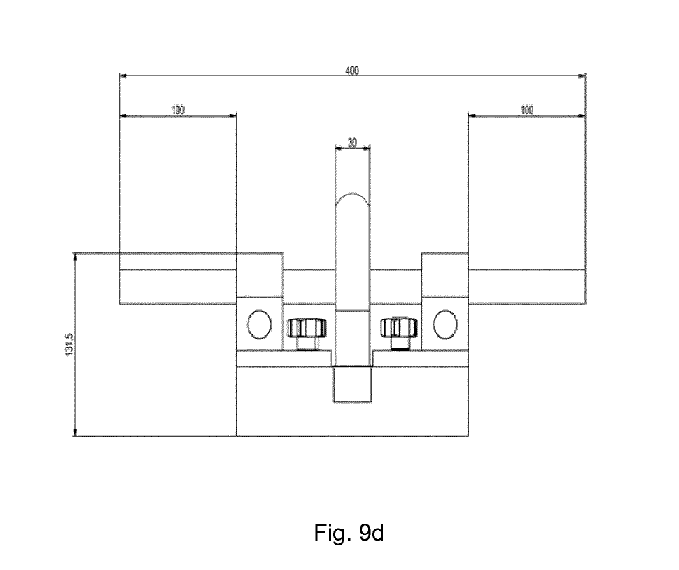

To evaluate the stretchability of the compositions in the experiments, coating layers of the compositions were applied to a stretchable paper and tested with a newly developed 3D formability tester that was developed by Omya and built by Norbert Schläfli Maschinen (Zofingen). Schematic drawings indicating major dimensions of the formability tester built of aluminium are shown in FIGS. 9a-d. The key element of the testing device is a profiled wheel with a diameter of 125 mm and a width of 30 mm. The profile covers half of the circumference of the wheel, and develops like a membrane in bulge tests from a flat surface to a semi-circle. The stretch level develops continuously along the profile having a total testing length of 19.6 cm (wheel diameter*pi/2) from 0% (30 mm stretching length and 30 mm stretched material) at the starting point to 57% (30 mm stretching length and 470.1 mm stretched material) at the end point. The wheel is part of an upper body of the testing instrument and is connected to two parallel rails that are also part of the upper body and guide the wheel when pulled manually for testing. The surface of the upper body that is showing towards the lower body is planar with the un-profiled section of the wheel. The lower body of the testing instrument is a massive block of aluminum with a 30 mm wide groove with broken edges not to cut the paper during testing when the profile is pressed into the paper. In order to avoid slipping paper during forming sandpaper can be glued just above the edge to firmly hold the testing paper between the upper and the lower body of the testing instrument.

For testing, coated paper is clamped between the upper and lower body of the testing instrument with the coated surface facing the groove of the lower body. Due to the fact that papers e.g. FibreForm® have a higher elongation at break in the machine direction (the direction the paper is produced, MD) the sample should be cut in the paper cross direction (CD) to use the higher stretchability in the MD, the wheel rolls in the CD and the stretch developed by the width of the wheel is applied in the MD, respectively. A trained person operates the testing instrument to ensure comparable results with regard to testing speed, clamping force and starting point of the measurement. The wheel rolls over the paper due to friction between paper and wheel surface and presses the profile into the paper. Obvious breaks of FibreForm® material without coating as described above have stretch levels of about 35-40% or brake after about 12 cm testing length. Coated samples were tested after 10 cm testing length or 29% of stretch.

To better visualize cracks, the coated surface is painted with Neocarmin W (MERCK), which is a testing liquid for colouring cellulose fibres that are visible at the cracks and gently cleaned with a soft tissue. Samples sufficiently large for microscopic evaluation are cut from the middle of the test area at a testing length of 10 cm and glued to a flat carton board. A stereo microscope is used to image the sample (Leica) at about 16 times magnification.

These images can be used for qualitative evaluation or further analysed by image analysis means.

12. Application and Testing of Coating Compositions

In the experiments, the coatings were applied to the substrate with a variable speed drawdown coater (K Control Coater 303 Model 625 available from Erichsen GmbH & Co. KG, Hemer, Germany; 12 speed steps increasing from 2 and 40 m/min and 10 application rods allowing increasing application weights at given speeds).

The coated samples were stretched in the 3D formability tester as described above.

Subsequently, the formation of cracks was investigated by the evaluation of microscopic images.

13. Binder Type Screening

A general screening was carried out to identify a suitable type of binder. In the screening, coating compositions comprising 100 parts (dry weight) of Filler 1 and 20 parts (dry weight) of various binders were prepared and applied to a stretchable paper substrate (100 g/m² FibreForm® (BillerudKorsnäs) (not a laminate)). The solids content of the compositions was about 60%. Coating was carried out in the machine direction and the coat weight was about 20 g/m². Sample strips were cut from the coated substrate. A textile color (Neocarmin) was applied to visualize cracks. The strips were stretched and microscopic images were taken. The images were then analyzed. The results are presented in Table 1 below.

TABLE 1

| | | | Solids | Coat | |
|---|---|---|---|---|---|
| | | Tg | content | weight | |
| Trade name | Type | (° C.) | (%) | (g/m²) | Cracking |
| Appretan E2100 | Pure | −30 | 61.4 | 20.2 | Acceptable |
| | acrylic | | | | |
| Appretan E6200 | SA | −20 | 61.5 | 20.6 | Acceptable |
| Appretan E4250 | VA | −15 | 61.5 | 19.4 | Acceptable |
| Primal 325 GB | SA | −25 | 60.8 | 20.5 | Acceptable |
| Primal P-308 MS | SA | 8 | 61.5 | 20.2 | Unacceptable |

“SA” refers to styrene-acrylic copolymer and “VA” refers to vinyl-acrylic copolymer.

As can be seen in Table 2, all binders giving an acceptable degree of cracking had a Tg below 8° C.

14. Binder Level

Tests were carried out to find an appropriate level/amount of binder. In the tests, coating compositions comprising 100 parts (dry weight) of Filler 1 and 10, 15 or 20 parts (dry weight) of the binder Appretan E2100 were prepared and applied to a stretchable paper substrate (100 g/m² FibreForm® (BillerudKorsnäs) (not a laminate)). The solids content of the compositions was about 60%. Coating was carried out in the machine direction and the coat weight was about 20 g/m². Sample strips were cut from the coated substrate. A textile color (Neocarmin) was applied to visualize cracks. The strips were stretched and microscopic images were taken. The images were then analyzed and the cracking in each coating was quantified. A “cracking number” was assigned to each composition. The results are presented in Table 2 below.

TABLE 2

| | | Solids | Coat | |
|---|---|---|---|---|
| | | content | weight | |
| Binder | Filler | (%) | (g/m²) | Cracking |
| 10 parts | 100 parts | 63.0 | 19.5 | 104k, Unacceptable |
| 15 parts | 100 parts | 63.1 | 20.2 | 63k, Acceptable |
| 20 parts | 100 parts | 62.0 | 61.4 | 48k, Acceptable |

From Table 2, it is concluded that at least 15 parts of binder is needed for an acceptable result. It is further concluded that more than 15 parts, such as at least 16 parts, is preferred as 20 parts resulted in less cracking than 15 parts.

15. Pigment Particle Size

Tests were carried out to find an appropriate pigment particle size. In the tests, coating compositions comprising 100 parts (dry weight) of inorganic filler and 20 parts (dry weight) of the binder Appretan E2100 were prepared and applied to a stretchable paper substrate (100 g/m² FibreForm® (BillerudKorsnäs) (not a laminate)). Three different inorganic fillers having different particle sizes were tested. The solids content of the compositions was about 60%. Coating was carried out in the machine direction and the coat weight was about 20 g/m². Sample strips were cut from the coated substrate. A textile color (Neocarmine, Merck Millipore) was applied to visualize cracks. The strips were stretched and microscopic images were taken. The images were then analyzed and the cracking in each coating was quantified. A cracking number was assigned to each composition. The results are presented in the Table 3 below.

TABLE 3
“BET SSA” refers to BET specific surface area.

| | BET | | | Solids | Coat | |
|---|---|---|---|---|---|---|
| | SSA | d₉₈ | d₅₀ | content | weight | |
| Filler | (m²/g) | (μm) | (μm) | (%) | (g/m²) | Cracking |
| Filler 2 | 6.8 | 10 | 1.4 | 63.2 | 19.0 | 29 k, Acceptable |
| Filler 1 | 11.5 | 5 | 0.7 | 61.4 | 19.1 | 48 k, Acceptable |
| Filler 3 | 18 | 2 | 0.5 | 56.8 | 19.2 | 64 k, Acceptable |

As can be seen in Table 3, all three types of fillers tested resulted in acceptable cracking. It is however concluded from Table 3 that it is preferred to use a filler having a BET specific surface area of less than 18 m²/g as Filler 1 and 2 resulted in substantially less cracking than Filler 3.

16. Paper Surface Properties

Printing properties of coating compositions according to the present disclosure as well as changes in the print quality after paper 3D-forming were investigated by a continuous lab-scale coating and printing trial.

The coating compositions comprised 100 parts (dry weight) of Filler 1 and 15 parts (dry weight) of one of three different binders (see Table 4). The coating compositions were applied to a stretchable paper substrate (100 g/m² FibreForm® (BillerudKorsnäs) (not a laminate)) with a Durrer continuous lab coating machine, using rod metering (C23, rod pressure of about 1 bar, rod revolution 12 rpm) at a coating speed of 20 m/min.

Coated paper surface properties were evaluated with regard to optical properties (CIE whiteness) and smoothness (Parker Print Surfaces).

3D-forming tests of the coated sheets were done as described above.

TABLE 4

| | | | Solids | Coat |
|---|---|---|---|---|
| Trade name | | Tg | content | weight |
| (binder) | Type | (° C.) | (%) | (g/m²) |
| Appretan E2100 | Pure acrylic | −30 | 58.3 | 19.5 |
| Appretan E6200 | SA | −20 | 58.7 | 19.0 |
| Primal 325 GB | SA | −25 | 58.1 | 18.0 |

As expected, coating compositions of Table 4 significantly improved the paper surface quality in terms of whiteness and smoothness. 3D-forming resulted in some tiny (but acceptable) cracks in the coating layers, which indicated that 15 parts is at the lower end of acceptable binder levels.

Filler/Binder Ratio; Upper Binder Limit

For evaluating the upper binder level, coating compositions were prepared according to Table 5.

The coating was applied to the substrate with a variable speed drawdown coater (K Control Coater 303 Model 625 available from Erichsen GmbH & Co. KG, Hemer, Germany; 12 speed steps increasing from 2 and 40 m/min and 10 application rods allowing increasing application weights at given speeds), and the samples tested with the 3D formability testing method described above.

TABLE 5

| Coating | B1 | B2 | B3 |
|---|---|---|---|
| Filler (parts by weight) | 100 | 100 | 100 |
| Appretan ® E6200 (parts by weight) | 20 | 30 | 40 |
| Rod #/Speed step | 3/2 | 3/2 | 4/2 |
| Coating Weight (g/m²) | 19.8 | 19.0 | 19.1 |
| Initial solids content (%) | 70.6 | 68.1 | 66.1 |
| Final solids content (%) | 60.0 | 60.8 | 48.1 |

An analysis showed that the coating becomes transparent at higher binder levels (i.e. >20 parts) in the coating formulation. Such higher binder levels are thus undesired from an optical point of view. Use of thickeners The influence of thickeners (rheology modifiers) on stretchability was investigated.

Coatings were applied with a Durrer continuous lab coating machine, using rod metering (C23, rod pressure of ca. 1 bar, rod revolution 12 rpm) at a coating speed of 20 m/min (see Table 6).

TABLE 6

| Coating | R1 | R2 |
|---|---|---|
| Filler 1 (parts by weight) | 100 | 100 |
| Appretan ® E6200 (parts by weight) | 20 | 20 |
| Rheocarb ® 101* (parts by weight) | 0.1 | |
| Rheocarb ® 121* (parts by weight) | | 0.1 |
| Coating Weight (g/m²) | 19.5 | 18.6 |
| Initial solids content (wt.-%) | 70.5 | 70.5 |
| Final solids content (wt.-%) | 60.0 | 60.1 |

*Thickener

The 3D formability tests of the coated sheets were carried out as described above. A visual evaluation identified the same (acceptable) crack pattern in the coatings including the thickeners (see Table 7) as in reference coatings without thickeners. It was concluded that the addition of thickeners had no negative impact on stretchability.

TABLE 7

| | Visual evaluation |
|---|---|
| R1 | Nearly no cracks |
| R2 | Nearly no cracks |

Clay-Containing Coating Compositions

The influence of clay on the stretchability of coating compositions was investigated. Further, clay was considered to be a representative example of other particles that may be included in the stretchable coatings. Coating composition were prepared applied according to Table 8.

Filler 4: Clay No. 1 (Hydragloss 90) high brightness ultrafine clay, d98=<2 μm; solids content 73% (available from Omya, Switzerland)

TABLE 8

| Coating | K1 | K2 | K3 |
|---|---|---|---|
| Filler 1 (parts by weight) | 100 | 75 | 50 |
| Filler 4 (parts by weight) | | 25 | 50 |
| Appretan ® E6200 (parts by weight) | 20 | 20 | 20 |
| Rheocarb ® 101 (parts by weight) | 0.1 | 0.1 | |
| Coating Weight (g/m²) | 19.5 | 18.0 | 18.3 |
| Initial solids content (wt.-%) | 70.5 | 69.4 | 68.4 |
| Final solids content (wt.-%) | 60.0 | 59.9 | 59.0 |

The 3D formability tests of the coated sheets were carried out as described above.

An visual evaluation of microscope images indicated satisfactory stretchability for the clay containing samples. Only a few tiny cracks were observed. Table 9 summarizes the evaluation.

TABLE 9

| | Visual evaluation |
|---|---|
| K1 | Nearly no cracks |
| K2 | Nearly no cracks |
| K3 | Nearly no cracks |

Styrene/Butadiene Binders

The stretchability of coating compositions comprising styrene/butadiene-based binders (SB binders) was investigated in another experimental setup.

The following SB binders were tested:
Litex® P5100: carboxylated styrene/butadiene copolymer dispersion; Tg−2° C. (available from Synthomer, Germany)
Litex® SX 1024: styrene/butadiene copolymer dispersion; Tg−15° C. (available from Synthomer, Germany)
Litex® S 7641: self-crosslinking styrene/butadiene copolymer dispersion; Tg−44° C. (available from Synthomer, Germany)

The coating compositions comprising the SB-binders are described in Table 10.

TABLE 10

| Coating | S1 | S2 | S3 |
|---|---|---|---|
| Filler 1 (parts by weight) | 100 | 100 | 100 |
| Litex ® P 5100 (parts by weight) | 20 | | |
| Litex ® SX 1024 (parts by weight) | | 20 | |
| Litex ® S 7641 (parts by weight) | | | 20 |
| Rod #/Speed step | 3/3 | 3/3 | 3/3 |
| Coating Weight (g/m²) | 19.0 | 20.5 | 19.8 |
| Initial solids content (%) | 71.3 | 71.3 | 70.0 |
| Final solids content (%) | 63.5 | 62.0 | 63.2 |

The coatings were applied to the substrate with a variable speed drawdown coater (K Control Coater 303 Model 625 available from Erichsen GmbH & Co. KG, Hemer, Germany; 12 speed steps increasing from 2 and 40 m/min and 10 application rods allowing increasing application weights at given speeds), and the samples were analyzed with the 3D formability testing method as described above.

Visual evaluation of the samples identified significant cracking (see Table 11) and it was concluded that that low Tg SB binders cannot be used in stretchable coatings of the present disclosure.

TABLE 11

| | Visual evaluation |
|---|---|
| S1 | Heavy cracks |
| S2 | Heavy cracks |
| S3 | Obvious cracks |

Further Acrylic Binders

The stretchability of three further acrylic binders (see below) were evaluated in an experimental setup.
Plextol® D270: aqueous emulsion of a thermoplastic acrylic polymer; Tg−42° C. (available from Synthomer, Germany)
Plextol® D5240: acrylic ester copolymer dispersion; Tg−43° C. (available from Synthomer, Germany)
Plextol® X 4427: aqueous emulsion of an acrylic copolymer; Tg−40° C. (available from Synthomer, Germany)

The coating compositions of Table 12 were prepared and evaluated.

| Coating | A1 | A2 | A3 |
|---|---|---|---|
| Filler 1 (parts by weight) | 100 | 100 | 100 |
| Plextol ® D 270 (parts by weight) | 20 | | |
| Plextol ® D 5240 (parts by weight) | | 20 | |
| Plextol ® X 4427 (parts by weight) | | | 20 |
| Rod #/Speed step | 3/3 | 3/3 | 3/3 |
| Coating Weight (g/m²) | 19.0 | 20.5 | 19.8 |
| Initial solids content (%) | 71.3 | 71.3 | 70.0 |
| Final solids content (%) | 63.5 | 62.0 | 63.2 |

The coating was applied to the substrate with a variable speed drawdown coater (K Control Coater 303 Model 625 available from Erichsen GmbH & Co. KG, Hemer, Germany; 12 speed steps increasing from 2 and 40 m/min and 10 application rods allowing increasing application weights at given speeds), and the samples analyzed with the 3D formability testing method as described above

A visual evaluation identified nearly no cracks (see Table 13) and it was concluded that also other low-Tg acrylic binders than those of Table 1 provide coating layers with satisfactory stretchability.

TABLE 13

| | Visual evaluation |
|---|---|
| A1 | Nearly no cracks |
| A2 | Nearly no cracks |
| A3 | Nearly no cracks |

Double Coating Concepts, Influence of Pre-Coating Weight

A double coating concept was evaluated. In a first experiment the influence of pre-coating weight was examined. Details of the pre-coatings (V1-V3) are given in Table 14 below. The pre-coating layers were applied with a Durrer continuous lab coating machine, using rod metering (rod pressure of ca. 1 bar, rod revolution 12 rpm) at a coating speed of 20 m/min.

TABLE 14

| Pre-coating | V1 | V2 | V3 |
|---|---|---|---|
| Filler 2 (parts by weight) | 100 | 100 | 100 |
| Appretan ® E6200 (parts by weight) | 20 | 20 | 20 |
| Coating Weight (g/m²) | 5.3 | 11.0 | 15.3 |
| Initial solids content (wt.-%) | 72.1 | 72.1 | 72.1 |
| Rod type | “smooth” | C15 | C23 |
| Final solids content (%) | 54.1 | 54.1 | 57.0 |

On the pre-coatings, top-coatings (D1-D3) having the characteristics of Table 15 were applied.

The second coating layers were applied with a Durrer continuous lab coating machine, using rod metering (C15, rod pressure of ca. 1 bar, rod revolution 12 rpm) at a coating speed of 20 m/min.

TABLE 15

| Coating | D1 | D2 | D3 |
|---|---|---|---|
| Filler 1 (parts by weight) | 100 | 100 | 100 |
| Appretan ® E6200 (parts by weight) | 20 | 20 | 20 |
| Coating Weight (g/m²) | 10.4 | 9.6 | 10.3 |
| Initial solids content (wt.-%) | 70.6 | 70.6 | 70.6 |
| Final solids content (wt.-%) | 55.4 | 55.4 | 55.4 |

3D formability testing of the coated sheets were carried out as described above.

The result of a visual evaluation is summarized in Table 16. It is concluded that higher pre-coating weights (e.g. >6 g/m², preferably >8 g/m²) are beneficial for the overall stretchability of stretchable double layer coatings.

TABLE 16

| | Visual evaluation |
|---|---|
| V1 + D1 | Obvious cracks |
| V2 + D2 | Nearly no cracks |
| V3 + D3 | Nearly no cracks |

Use of Optical Brightening Agents

A double coating concept with stretchable coatings was evaluated. In an experiment the influence of optical brightening agents (OBAs) in the top-coating layer was evaluated.

The pre-coating layers V4 and V5 were the same as V3 (see Table is).

The pre-coating layers were applied with a Durrer continuous lab coating machine, using rod metering (C23, rod pressure of ca. 1 bar, rod revolution 12 rpm) at a coating speed of 20 m/min.

On the pre-coatings, top-coatings (O1 and O2) according to Table 17 were applied. The second coating layers were applied with a Durrer continuous lab coating machine, using rod metering (C15, rod pressure of ca. 1 bar, rod revolution 12 rpm) at a coating speed of 20 m/min.

TABLE 17

| Coating | O1 | O2 |
|---|---|---|
| Filler 1 (parts by weight) | 100 | 100 |
| Appretan E6200 (parts by weight) | 20 | 20 |
| PVA BF-04 (parts by weight) | | 0.2 |
| Blancophor PT (parts by weight) | | 0.25 |
| Coating Weight (g/m²) | 10.3 | 9.4 |
| Initial solids content (%) | 70.6 | 70.4 |
| Final solids content (%) | 55.4 | 56.8 |

3D formability tests of the coated sheets were carried out as described above.

A visual evaluation of the tested samples is summarized in Table 18. It is concluded that the use of OBA in the top-coating formulation of a double coating concepts does not influence the stretchability of the coating layer. It is likely that a similar result would have been obtained with a single layer concept.

TABLE 18

| | Visual evaluation |
|---|---|
| V4 + O1 | Nearly no cracks |
| V5 + O2 | Nearly no cracks |

Use of TiO₂

A double coating concept with stretchable coatings was evaluated. In an experiment the influence of additional titanium dioxide in the top-coating composition was evaluated.

The pre-coating layers V6 and V7 were the same as V3 (see Table 15). The pre-coating layers were applied with a Durrer continuous lab coating machine, using rod metering (C23, rod pressure of ca. 1 bar, rod revolution 12 rpm) at a coating speed of 20 m/min.

On the pre-coating layers, top-coatings according to Table 19 were applied. The second coating layers were applied with a Durrer continuous lab coating machine, using rod metering (C15, rod pressure of ca. 1 bar, rod revolution 12 rpm) at a coating speed of 20 m/min.

TABLE 19

| Coating | X1 | X2 |
|---|---|---|
| Filler 1 (parts by weight) | 100 | 80 |
| Filler 5 (parts by weight) | | 20 |
| Appretan E6200 (parts by weight) | 20 | 20 |
| Coating Weight (g/m²) | 10.3 | 10.0 |
| Initial solids content (%) | 70.6 | 69.6 |
| Final solids content (%) | 55.4 | 57.2 |

3D formability tests of the coated sheets were carried out as described above.

Table 20 summarizes a visual evaluation of the test results. It is concluded that addition of TiO₂ to the top-coating formulation results in tiny local cracks of acceptable character. It is likely that a similar result would have been obtained with a single layer concept.

TABLE 20

| | Visual evaluation |
|---|---|
| V6 + X1 | Nearly no cracks |
| V7 + X2 | Local tiny cracks |

Multivac Forming Test of Stretchable FibreForm Laminates

A stretchable FibreForm® paper (100 g/m², marketed by BillerudKorsnäs, Sweden) was coated with 10 g/m² of a pre-coating and 10 g/m² of top-coating 1 or 2 (see Table 21). In the top-coatings, the specific surface area of the inorganic filler was larger than in the pre-coating. When comparing the top-coatings, the specific surface area of the inorganic filler was larger in top-coating 2 than in top-coating 1. The coated paper was calendared using a soft nip calender (temperature: 140° C.; line load: 70 kN/m; speed: 300 m/min).

As a reference, the same stretchable FibreForm® paper was coated with 15 g/m² of a reference coating (see Table 21). The coated reference paper was calendared using another soft nip calender (temperature: 180° C.; line load: 50 kN/m; speed: 300 m/min).

| | Pre- | Top- | Top- | |
|---|---|---|---|---|
| Coating composition | coating | coating 1 | coating 2 | Ref. |
| Filler 2 (parts) | 100 | | | |
| Hydorcarb 95* (parts) | | | 100 | |
| Covercarb 75* (parts) | | 100 | | |
| Filler 3 (parts) | | | | 100 |
| Latex Primal 325 GB (parts) | 20 | 20 | 20 | |
| DL 950 (parts)** | | | | 15 |
| Shading Dye (parts) | 0.03 | 0.03 | 0.03 | 0.03 |
| Rheocoat 35 (parts) | 0.15 | 0.2 | 0.2 | 0.2 |
| NaOH (parts) | 0.07 | 0.07 | 0.07 | 0.07 |
| Viscosity aim | 1400 | 1400 | 1400 | 1400 |
| Solids content (%) | 68 | 66 | 70 | 68 |
| Coat weight (g/m²) | 10 | 10 | 10 | 15 |

*Available from OMYA
**Styrene/butadiene binder

The coated material was printed on the coated side and then laminated with 150 g/m² FibreForm. 30 g/m² polyethylene (PE) was used as glue between the layers. Another 40 g/m² was applied to the backside of the material. The printing left unprinted areas for analysis (see below).

Reels of the laminate material were formed on the MultiVac line at BillerudKorsnäs' Forming Lab at Gruvön, Sweden. A ham tray form was used with forming depth of 20 mm and an edge angle of 37°. The material was preheated using a 105° C. heating plate for approximately 1 s and then stretched in contact with the plate into the final forming depth within 0.2 seconds. The forming was low abrasive and any cracks appearing would not have originated from contact with the form.

For crack visualizing, the unprinted areas were treated with a fine pigment powder and the surplus was brushed away using a soft brush. A USB microscope was then used to take images of the samples.

The top-coating 1 concept showed the least cracks. The top-coating concept 2 showed more, but still acceptable, cracking. The reference sample showed unacceptable cracking.

The MultiVac forming test thus shows that the inventive concept works in an industrial scale setting. Further, it confirms that a relatively small specific surface area for the inorganic filler is beneficial and that an acrylic binder works, while a styrene/butadiene binder results in unacceptable cracking.

Finally, it can be concluded that calendaring seems to improve the cracking behavior, which might (without being limited to any specific scientific theory) be attributed to a densification of the coating layer leading to a more flexible coating with higher degree of bonded area.

1. A coated paper material comprising a paper substrate coated with a composition comprising:
at least one acrylic binder having a glass transition temperature (Tg) of −3° C. or lower, and
at least one inorganic filler having a BET specific surface area in the range of 1.0 to 30.0 m2/g,
wherein the dry weight ratio of said at least one acrylic binder to the at least one inorganic filler is between 15:100 and 20:100, such as between 16:100 and 20:100.

2. The coated paper material according to claim 1, wherein the paper substrate comprises at least two paper layers including a top paper layer that is coated with the composition.

3. The coated paper material according to claim 1, wherein the stretchability (ISO 1924/3) of the paper substrate or the top paper layer thereof is at least 5%, in the machine direction (MD) and/or the cross direction (CD).

4. The coated paper material according to claim 1, wherein the Tg of the at least one acrylic binder is −10° C. or lower.

5. The coated paper material according to claim 1, wherein the BET specific surface area of the at least one inorganic filler is in the range of 2.0 to 20.0 m²/g.

6. The coated paper material according claim 1, wherein the coat weight is 8-30 g/m².

7. The coated paper material according claim 1, wherein the at least one acrylic binder is selected from the group consisting of: acrylic homopolymers; methacrylic homopolymers; copolymers composed of at least two different monomers, one monomer having an acrylic or methacrylic functional group and the other monomer having a functional group selected from the group consisting of styrene, vinyl and allyl; and mixtures thereof.

8. The coated paper material according to claim 1, wherein the at least one acrylic binder is an acrylic homopolymer, a vinyl-acrylic copolymer, a styrene-acrylic copolymer, or a mixture thereof.

9. The coated paper material according to claim 1, wherein the weight median particle size d₅₀ of the at least one inorganic filler is in the range of 0.1 to 5.0 μm.

10. The coated paper material according to claim 1, wherein the at least one inorganic filler is selected from the group consisting of calcium carbonate containing material, clay, kaolin and mixtures thereof, wherein calcium carbonate containing material is selected from the group consisting of natural ground calcium carbonate (GCC), precipitated calcium carbonate (PCC), dolomite and mixtures thereof.

11. The coated paper material according to claim 1, wherein the at least one acrylic binder and the at least one inorganic filler together constitute at least 90 wt.-% of the composition, based on the dry weight of the composition.

12. The coated paper material according to claim 1, wherein a coated surface of the coated paper material is printed, which printed surface is optionally covered by a barrier layer.

13. A package comprising at least one wall composed of the coated paper material according to claim 1.

14. The coated paper material according to claim 1, comprising a bulge or relief formed by stretching a portion of the coated paper material.

15. A method of forming a three-dimensional pattern comprising a step of subjecting an article comprising a coated paper material according to claim 1 to a forming operation, to form the three-dimensional pattern in the coated paper material, wherein part of the coated paper material is stretched during the forming operation.

16. A three-dimensional article comprising structural elements composed of a coated paper material according to claim 1.

17. The coated paper material according to claim 1, wherein the dry weight ratio of said at least one acrylic binder to the at least one inorganic filler is between 16:100 and 20:100.

18. The coated paper material according to claim 3, wherein the stretchability (ISO 1924/3) of the paper substrate or the top paper layer thereof is at least 7% in the machine direction (MD) and/or the cross direction (CD).

19. The coated paper material according to claim 4, wherein the Tg of the at least one acrylic binder is −15° C. or lower.

20. The coated paper material according to claim 19, wherein the Tg of the at least one acrylic binder is −20° C. or lower.

21. The coated paper material according to claim 5, wherein the BET specific surface area of the at least one inorganic filler is in the range of 3.0 to 17.5 m²/g.

22. The coated paper material according to claim 21, wherein the BET specific surface area of the at least one inorganic filler is in the range of 5.0 to 13 m²/g.

23. The coated paper material according to claim 9, wherein the weight median particle size d₅₀ of the at least one inorganic filler is in the range of 0.4 to 2.0 μm.

24. The package according to claim 13 comprising a bulge or relief formed by stretching a portion of the coated paper material.

25. The method of claim 15, wherein the forming operation is press-forming or thermo-forming.
